(19) United States
(12) Patent Application Publication
(10) Pub. No.: US 2023/0040652 A1
(43) Pub. Date: Feb. 9, 2023

(54) A Cyclic two-way Bidding Matching Method and System Based on The Needs of Both Sides of Job-hunters and Recruiters

(71) Applicant: Mengqiang Zhang, MaAnshan (CN)

(72) Inventor: Mengqiang Zhang, MaAnshan (CN)

(21) Appl. No.: 17/969,101

(22) Filed: Oct. 19, 2022

Related U.S. Application Data
(63) Continuation-in-part of application No. PCT/CN2021/091237, filed on Apr. 30, 2021.

(30) Foreign Application Priority Data
May 10, 2020 (CN) 202010385723.3

(51) Int. Cl. G06Q 10/06; G06Q 10/10

(52) U.S. Cl. CPC G06Q 10/063112; G06Q 10/1053

(57) ABSTRACT

This invention application presents a cyclic two-way bidding matching method and system used to periodically match resumes and recruitment positions by the way of bidding matching. Every round of bidding matching cycle comprises: comparing the pre-matching items of resumes and positions, and establishing a pre-matching relation between the positions and resumes if their pre-matching items match each other; based on the pre-matching relation, quantifying each resume's attraction and each position's attraction; building the bidding queue of resumes and the bidding queue of positions, then the two-way bidding matching is implemented to match resumes and positions to get the two-way optimal matching results. In every round of bidding matching cycle, a certain number of matching results are generated for each resume and for each position. As the bidding matching periodically runs rounds after rounds, more and more two-way optimal matching results are generated.

### REFERENCE TO RELATED APPLICATIONS

The present invention application is a continuation of international application No. PCT/CN2021/091237, filed on Apr. 30, 2021, which claims priority to Chinese patent application No. 202010385723.3 filed on May 10, 2020. Both of the related applications are incorporated herein by reference in their entirety.

### TECHNICAL FIELD

The invention relates to data processing and analysis, and in particular to a technology for automatically matching both sides of job-hunters and recruiters.

### DESCRIPTION OF RELATED ART

In the online job-hunting and recruitment industry, when both job-hunters and recruiters face with a large number of recruitment positions and resumes stored in the computer system, it is extremely time-consuming, labor-intensive and inefficient if they only rely on manual reading and screening to find the suitable positions or resumes. So the industry has developed the use of data processing capabilities of computer systems to automatically match positions and resumes, that is, match positions to resumes and match resumes to positions, then the matching results are recommended to recruiters and job-hunters. This kind of solutions can improve the efficiency of users, that is, recruiters and job-hunters, to a certain extent. The related solutions or related arts that are used in matching resumes of job-hunters and positions of recruiters are to interpret and analyze the data such as resume content and position content, and quantify the matching degree between the positions and resumes. Then every time a user, that is, a recruiter or a job-hunter, accesses the system, the matching results of resumes or positions are generated for the visiting user according to the matching degree from high to low. This solutions has the following two attributes.

First, the generating of matching results is decentralized in process and scattered in time, because the generating of matching results are triggered by the behavior of each job-hunter or recruiter accessing the system, and everyone's time of accessing the system is different.

Second, for a recruiter who accesses the system, the matching result generated for this recruiter is a batch of resumes with the highest matching degree to the position of this recruiter. Therefore the matching result is only an one-way optimal for this recruiter. But for some of the resumes matched to this recruiter, there are usually many recruiters with higher matching degree than this one, so it is not appropriate to match these resumes to this recruiter. On the other hand, for a job-hunter who accesses the system, the matching result generated for this job-hunter is a batch of positions with the highest matching degree to the resume of this job-hunter. Therefore the match result is only an one-way optimal for this job-hunter. But for some of the job positions matched to this job-hunter, there are usually many job-hunters with higher matching degree than this one.

### SUMMARY

The first aspect of the present invention application is a cyclic two-way bidding matching method based on the needs of both sides of job-hunters and recruiters, which comprising the following five periodic cycle steps:

establishing pre-matching relations, for the the existing and newly inputted recruitment positions and job-hunting resumes in the bid-matching system, compare the pre-matching items of the positions and the resumes, and establish a pre-matching relation between the positions and resumes whose pre-matching items match each other; the pre-matching item include: industry field, job title, work area;

quantitatively calculating attraction, for the resumes and positions that have established the pre-matching relation, quantitatively calculate the attraction value of each resume to each position, that is, the attraction value of resume; quantitatively calculate the attraction value of each position to each resume, that is, the attraction value of position; the quantified factors for the attraction value of resume include: the matching degree of a resume to a position; the quantified factors for the attraction value of position include: salary offered by a position;

triggering bid-matching cycles, set the bid-matching system to run periodically, the next step of bid-matching processing is triggered to perform at the beginning of every round of bid-matching cycle; the other four steps also perform in every round of bid-matching cycle;

bid-matching processing, the procedure of implementing the two-way bidding matching from the two directions of resume attraction and position attraction, and generating the bidding matching results includes: in each single bid-matching processing, run bid-matching processing A first, and then run bid-matching processing B; repeatedly run the single bid-matching processing in a loop until the completion of the two-way bidding matching; the bid-matching processing A and B must be one of the following two categories of type I and type II;

the bid-matching processing A of type I takes recruitment positions as the bidding matching initiator, and performs the following operations for each current position being processed: first sort the resumes that have established the pre-matching relation with the current position in descending order according to the attraction value of resume, thereby forming a bidding queue of resumes; and then based on sorting priority, select a certain number of resumes that are ranked high and meet the filter criteria into the quasi-matched resume set of the current position; send matching invitations from the current position to the resumes that have been newly selected into the quasi-matched resume set in the current bid-matching processing A;

the bid-matching processing B of type I performs the following operations for each current resume being processed: for the positions that have sent matching invitations to the current resume, quantify the value of overall benefits that each position can bring to the current resume; sort these positions in descending order according to the value of overall benefits, thereby forming a bidding queue of positions, and then based on sorting priority, select a certain number of positions that are ranked high into the quasi-matched position set of the current resume; send matching rejection from the current resume to the positions that have not been selected into the quasi-matched position set in the current bid-matching processing B; the quantified factors for the value of overall benefits include: the attraction value of position;

the bid-matching processing A of type II takes job-hunting resumes as the bidding matching initiator, and performs the following operations for each current resume being processed: first sort the positions that have established the pre-matching relation with the current resume in descending order according to the value of overall benefits that each position can bring to the current resume, thereby forming a bidding queue of positions; and then based on sorting priority, select a certain number of positions that are ranked high and meet the filter criteria into the quasi-matched position set of the current resume; send matching invitations from the current resume to those positions that have been newly selected into the quasi-matched positon set in the current bid-matching processing A; the quantified factors for the value of overall benefits include: the attraction value of position;

the bid-matching processing B of type II performs the following operations for each current position being processed: sort the resumes that have sent matching invitations to the current position in descending order according to the attraction value of resume, thereby forming a bidding queue of resumes, and then based on sorting priority, select a certain number of resumes that are ranked high into the quasi-matched resume set of the current positon; send matching rejection from the current positon to the resumes that have not been selected into the quasi-matched resume set in the current bid-matching processing B;

the completion of the two-way bidding matching is that the quasi-matched resume set of each position participating in the bidding matching has no newly selected resume, or the quasi-matched position set of each resume participating in the bidding matching has no newly selected position; at this time, the resumes in the quasi-matched resume set are successfully matched to the current position, and the positions in the quasi-matched position set are successfully matched to the current resume;

feedback for the bidding matching results, after the completion of the bidding matching, the bidding matching results can be fed back to users by actively pushing or responding to users' query; then users can process the bidding matching results.

The second aspect of the present application is a cyclic two-way bidding matching system which comprising the following five modules running in periodic cycle:

module for establishing pre-matching relations, for the existing and the newly inputted recruitment positions and job-hunting resumes in the bid-matching system, compare the pre-matching items of the positions and the resumes, establish a pre-matching relation between the positions and resumes whose pre-matching items match each other; the pre-matching item include: industry field, job title, work area;

module for quantitatively calculating attraction, for the resumes and positions that have establish the pre-matching relation with each other, quantitatively calculate the attraction value of each resume to each position, that is, the attraction value of resume; quantitatively calculate the attraction value of each position to each resume, that is, the attraction value of position; the quantified factors for the attraction value of resume include: the matching degree of a resume to a position; the quantified factors for the attraction value of position include: salary offered by a position;

module for triggering bid-matching cycles, set the bid-matching system to run periodically, the bid-matching processing will be triggered at the beginning of each round of bid-matching cycle; the other four modules also run in every round of bid-matching cycle;

module for bid-matching processing, the procedure of implementing the two-way bidding matching from the two directions of resume attraction and position attraction, and generating the bidding matching results includes: in each single bid-matching processing, run the bid-matching unit A first, and then run the bid-matching unit B; repeatedly run the single bid-matching processing in a loop until the completion of the two-way bidding matching; the bid-matching unit A and unit B must be one of the following two categories of type I and type II;

the bid-matching unit A of type I takes the recruitment positions as the bidding matching initiator, and performs the following operations for each current position being processed: first sort the resumes that have established the pre-matching relation with the current position in descending order according to the attraction value of resume, thereby forming a bidding queue of resumes; and then based on sorting priority, select a certain number of resumes that are ranked high and meet the filter criteria into the quasi-matched resume set of the current position; send matching invitations from the current position to the resumes that have been newly selected into the quasi-matched resume set in the current processing of bid-matching unit A;

the bid-matching unit B of type I performs the following operations on each current resume being processed: for the positions that have sent matching invitations to the current resume, quantify the value of overall benefits that each position can bring to the current resume; sort these positions in descending order according to the value of overall benefits, thereby forming a bidding queue of positions; then based on sorting priority, select a certain number of positions that are ranked high into the quasi-matched position set of the current resume; send matching rejection from the current resume to the positions that have not been selected into the quasi-matched position set in the current processing of bid-matching unit B; the quantified factors for the value of overall benefits include: the attraction value of position;

the bid-matching unit A of type H takes the job-hunting resumes as the bidding matching initiator, and performs the following operations for each current resume being processed: first sort the positions that have established the pre-matching relation with the current resume in descending order according to the value of overall benefits that each position can bring to the current resume, thereby forming a bidding queue of positions; and then based on sorting priority, select a certain number of positions that are ranked high and meet the filter criteria into the quasi-matched position set of the current resume; send matching invitations from the current resume to the positions that have been newly selected into the quasi-matched positon set in the current processing of bid-matching unit A; the quantified factors of the overall benefits include: the attraction value of position;

the bid-matching unit B of type HI performs the following operations on each current position being processed: sort the resumes that have sent matching invitations to the current position in descending order according to the attraction value of resume, thereby forming a bidding queue of resumes; then based on sorting priority, select a certain number of resumes that are ranked high into the quasi-matched resume set of the current positon; send matching rejection from the current positon to the resumes that have not been selected into the quasi-matched resume set in the current processing of bid-matching unit B;

the completion of the two-way bidding matching is that the quasi-matched resume set of each position participating in the bidding matching has no newly selected resume, or the quasi-matched position set of each resume participating in the bidding matching has no newly selected position; at this time, the resumes in the quasi-matched resume set are successfully matched to the current position, and the positions in the quasi-matched position set are successfully matched to the current resume;

module for feedback of bidding matching results, after the completion of the bidding matching, the bidding matching results can be fed back to users by actively pushing or responding to users' query; then users can process the bidding matching results.

### BRIEF DESCRIPTION OF THE DRAWINGS

The invention will be described with respect to specific embodiments, and reference will be made to the drawings in which:

FIG. 1 is a flow chart of the cyclic two-way bidding matching method based on the needs of both job-hunters and recruiters;

FIG. 2 is a flow chart of quantitative calculation of matching degree;

FIG. 3 is a schematic diagram of Type I bid-matching processing A and B;

FIG. 4 is a schematic diagram of Type II bid-matching processing A and B;

FIG. 5 is the overall structure diagram of the cyclic two-way bidding matching system based on the needs of both sides of job-hunters and recruiters.

### DETAILED DESCRIPTION

Different from the existing technical solutions, the main technical invention points of the present invention application are simply introduced as follows.

Firstly, bidding matching runs periodically. In each bidding matching cycle, the matching result generated for each resume is a certain number of positions, and only a part of all the positions that can be matched; the matching result generated for each position is a certain number of resumes, and only a part of all the resumes that can be matched. With the continuous occurrence of subsequent bidding matching cycles, more and more positions are matched to each resume, and more and more resumes are matched to each position. This is completely different from the existing technical solutions. The existing technic solutions do not generate matching results periodically, and only generate matching results based on the matching systems' response to each user's access behaviour.

Secondly, in each bidding matching cycle, matching results are generated in advance within the scope of all active resumes and active positions, and the number of the matching result for everyone is dynamically adjusted according to the activity level of each resume and each position. This is completely different from the existing technical solutions which only generate matching results after access behaviour to the matching systems, and the number of matching result for everyone is not dynamically adjusted according to the activity level of everyone. The existing technical solutions only respond to users' access behaviour. When a user accesses a matching system to obtain the matching result, the matching system sorts all the resumes or positions according to the matching degree from high to low, and then uses the entire sorting as the generated matching result.

Thirdly, in every bidding matching cycle, each generated matching result is a two-way (means two direction or bidirectional) optimal matching that complies with the bidding matching constraints. This is completely different from the existing technical solutions, and the matching results generated by the existing technical solutions are all one-way optimal. For example, based on the technical solution of the present invention application, a matching relation is established between the resume A and the recruitment position B. Then for the resume A, the position B is one of the best matches that conforms with the bidding matching constraints. At the same time, for the position B, the resume A is also one of the best matches that conforms with the bidding matching constraints. Based on the existing technical solutions, if the position M is matched to the resume N, it is only because the positon M is one of the best matches for the resume N. However, for the positon M, the resume N's matching degree may too low to get matched. In this case, it is difficult for resume N and position M to obtain good results in the follow-up recruitment process, but only increases many costs for both parties, such as time, physical strength, opportunity and so on.

In a word, in order to obtain the real optimal matching results, the present invention application introduces the features of two-way competition and multi-factor constraints that exist objectively in the real world, and integrates these features into periodically running cycles. As a combined invention, some components of the technical scheme of the present invention application are common practices. But when they are combined to form a closely related whole, they constitute a brand-new invention with unique effect.

As showed in the following contents, the technical scheme of the present application is described clearly and completely in combination with the attached drawings.

The first aspect of the technical scheme of the present application, a cyclic two-way bidding matching method based on the needs of both sides of job-hunters and recruiters is described in the following details with references to the accompanying drawings.

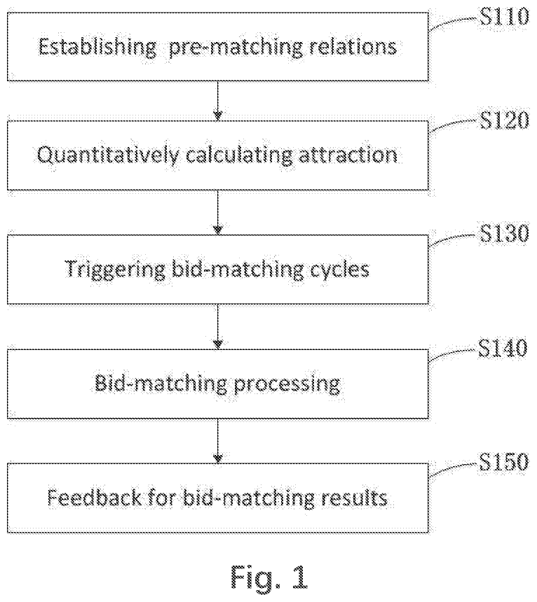

As shown in FIG. 1, the figure shows a flow chart of the cyclic two-way bidding matching method which includes the following five periodic cycle steps.

Step S110: Establishing pre-matching relations, compare the pre-matching items of the recruitment positions and the job-hunting resumes, and establish a pre-matching relation between the positions and resumes whose pre-matching items match each other;

Step S120: quantitatively calculating attraction, for the resumes and positions that have establish the pre-matching relation, quantitatively calculate each resume's attraction to each position and each position's attraction to each resume;

Step S130: triggering bid-matching cycles, set the bid-matching system to run periodically, the next step of step S140 named bid-matching processing is triggered to perform at the beginning of every round of bid-matching cycle;

Step S140: the procedure of implementing the two-way bidding matching from the two directions of resumes' attraction and positions' attraction, and generating the bidding matching results is: in each single bid-matching processing, run the bid-matching processing A first, and then run the bid-matching processing B; repeatedly run the single bid-matching processing in a loop until the completion of the bid-matching processing;

Step S150: feedback for the bidding matching results, after the completion of the bid-matching processing, the bidding matching results can be fed back to users by actively pushing or responding to users' query; then users can process the matching results.

Specifically, in step S110: Process the existing and newly inputted recruitment positions and job-hunting resumes in the bid-matching system, and compare the pre-matching items of the positions and the resumes; establish a pre-matching relation between the positions and resumes whose pre-matching items match each other. The reason for the design of this step is that it is necessary to match a position to a resume only if their pre-matching items match each other. For example, the pre-matching item of the recruitment position P has three sub items as ‘industry field: machinery manufacturing, job title: product manager, work area: Shanghai’, and the pre-matching item of the resume R has three sub items as ‘industry field: Internet, job title: product manager, work area: Shanghai’. On the sub item of ‘industry field’, the position P has no intersection with the resume R, so not all sub items of the position P match all that of the resume R. Therefore the pre-matching item of the position P does not match the pre-matching item of the resume R. It is no need to establish the pre-matching relation between the position P and the resume R. Although they are both product managers, the skill difference between a machinery industry product manager and an Internet product manager is obvious and huge.

To establish the pre-matching relation between a position and a resume, all sub items of the pre-matching item must match. For a single sub item, if the intersection on the sub item is not empty, then it matches.

The pre-matching item provided by the present invention application has three sub items, such as industry field, job title, and work area. Based on actual need and comprehensively weighing the cost and utility of processing pre-matching items, other more sub items can also be introduced. For example, the monthly salary range offered by recruiters and the monthly salary range asked by job-hunters can also be included.

Specifically, in step S120: Quantitatively calculating attraction. For the resumes and positions that have establish the pre-matching relation with each other, quantitatively calculate the attraction value of each resume to each position, that is, the attraction value of resume; quantitatively calculate the attraction value of each position to each resume, that is, the attraction value of position.

The attraction value of resume measures the attractiveness of a resume to a recruiter, that is, to what extent a job-hunter's conditions mainly reflected in the resume meet the requirements of the recruiter's recruitment position. The attraction value of position measures the attractiveness of a recruitment position to a job-hunter, and this attraction is based on the salary and benefits offered by a recruiter. The following content further illustrates the specific implementation for quantifying resume attraction and quantifying position attraction in conjunction with the accompanying drawings.

The first aspect of step S120: quantifying resume attraction is introduced as follows. The core quantified factor of the resume attraction is the matching degree between the content of a resume and the content of a position. Therefore, it is necessary to apply natural language processing, semantic recognition, artificial intelligence and other technologies to extract and analyze the content of resumes and the content of recruitment positions, identify their semantics, and compare their similarities and differences. And then get the comprehensive matching degree of resumes to positions by quantitatively calculating. In order to further improve the accuracy and effectiveness of the result of the quantitative calculation, the content quantitatively calculated may not be limited to the content of resumes and positions, but can also be combined with the historical matching effect data of resumes and positions, the behavior data of job-hunters and recruiters, as well as the public information of job-hunters and recruiters on the Internet, such as social networks.

The technical solution of the present invention application does not involve related technologies such as natural language processing, semantic recognition, big data processing, artificial intelligence, behavior analysis, effect statistics, etc., so only a simplified embodiment is provided below to show that it is feasible to obtain the attraction value of resume by the quantitative calculation.

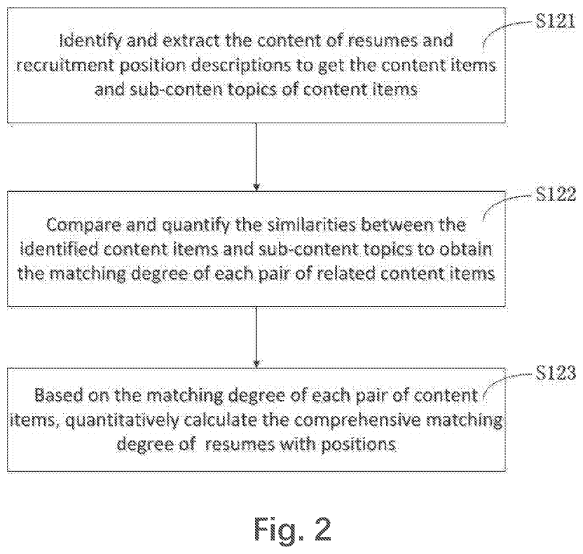

FIG. 2 shows a simplified quantitative calculation used to get the attraction value of resume. The content of FIG. 2 is described as follows.

Step S121, identify and extract the content of resumes and positions. Then obtain the content items included in each part of the content and the sub-content topics under the content items.

Step S122, analyze, compare, and quantify the similarities and differences between the identified content items and sub-content topics, and then calculate the matching degree of every pair of content items which are compared.

Step S123, based on the matching degree of every pair of content items, calculate each resume's comprehensive matching degree to each position.

In the step S121, the content of each part of resumes to be identified and extracted includes, but is not limited to, educational experience, work experience, project experience, technical ability, personal expertise, salary requirements, job title, industry, and work area. The content of each part of position descriptions to be identified and extracted includes, but not limited to, responsibilities, qualifications, job title, industry, work area, salary and benefits.

In the step S123, the attraction value of resume can be obtained through an appropriate calculation method such as weight assignment. In practice, it can support recruiters to customize which conditions are necessary conditions, and to customize the importance ranking or weight value for non-essential conditions, Then the obtained resume ranking results are highly in line with the individual needs of recruiters.

The second aspect of step S120: quantifying the attraction of recruitment positions is introduced as follows.

The quantified factor for position attraction is salary benefit. Besides economic salary, salary benefit can also include non-economic benefits. Therefore, the calculation and comparison for salary benefit should distinguish different internal structure of salary benefit. The simpler implementation is that salary benefit just has economic salary without non-economic benefits, that is,

the attraction value of position=economic salary.

Economic salary is the economic return issued to the employee of a position, which can be the monthly salary calculated on a monthly basis, and can also include bonuses, commuting allowances, and communication allowances. Non-economic benefits is a kind of attraction to job-hunters based on career promotion opportunities, workplace environment, company organizational culture and other factors.

For the economic salary mentioned above, the calculation and comparison steps includes: first, convert the different parts included in the salary package into the same payment time span; then, directly add the payment amounts of the different parts.

For non-economic benefits, with the enrichment of data and information, the influence of non-economic benefits in online recruitment is increasing. Because the network environment and technical equipments provide recruiters with opportunities to display all aspects of their company information, such as text, pictures, videos, etc. There are also various current employees' and former employees' comments and evaluation information about recruiters. These word-of-mouth information is also a unique window to present all aspects of recruiters' status. The development of big data technology has also created more and more possibilities for mining more information beneath the surface of recruiters. Therefore, it is completely feasible in practice to quantify and calculate non-economic benefits with a unified standard.

In order to include non-economic benefits, one of the following algorithms can be selected to calculate the comprehensive salary benefit package including economic salary and non-economic benefits.

Comprehensive salary and benefits can be calculated on a weighted basis, such as:

the attraction value of position=economic salary*weight of economic salary+non-economic benefits*weight of non-economic benefits

Calculate comprehensive salary and benefits based on influence factors, such as:

the attraction value of position=economic salary*F(non-economic benefits).

In this formula, F(X) is a function to calculate the influence factor of non-economic benefits. To get the specific value of F(X), the calculation rules of F(X) can be set individually. In the above calculation formulas, the symbol ‘*’ indicates multiplication calculation.

In practice, job-hunters can freely set whether to include non-economic benefits into the salary benefit package. If job-hunters include non-economic benefits into the salary benefit package, the above-mentioned formulas, that is, weighted algorithm and influence factor algorithm, can be set individually. In addition, the technical solution of the present invention application needs to establish the pre-matching relation between positions and resumes by the pre-matching item before entering the bid-matching processing. This means that different and individual calculation methods for salary benefit can be used for positions and resumes from different regions and different industries. The algorithm structure and calculation method of the present application bring convenience and improve the flexibility and effectiveness for the quantitative calculation of salary benefit.

In the steps of S110 and S120, it is no need to process the existing resumes and positons which have been processed and have no modification. But for the newly inputted resumes and recruitment positions, and for the resumes and positions which have been modified, they must be processed in the steps of S110 and S120.

Specifically, in step S130: triggering bid-matching cycles, the cyclic bid-matching system periodically triggers the bid-matching processing of step S140 to run at the beginning of every round of bid-matching cycle. As the bid-matching processing is executed periodically round by round, the optimal matching results that meet the bidding matching constraints are continuously provided to both job-hunters and recruiters in batches. Because each batch is the optimal matching result that meet the bidding matching constraints, with the number of batches growing, more and more optimal bidding matching results will be generated for job-hunters and recruiters.

It must be emphasized, although it is said that step S140 is periodically triggered to run, it does not mean that step S110, S120, S130 and step S150 will no longer run after their first running. Actually, all the five steps, that is, from step S110 to step S150, run periodically. On another perspective, not only S140 runs, but all S110, S120, S130, S140, and S150 run in every periodic cycle.

The cyclic bid-matching processing can be set to different cycle rules according to specific needs. For example, every round of cycle can be set to begin to run after a fixed interval length of time, such as 5 hours, 6 hours or 12 hours, etc. Every round of cycle can also be set to begin to run at one or more fixed time points, such as 5:00 am and 12:10 pm. If the time interval of the two adjacent bid-matching processing is set to be shorter and shorter, for example, less than 20 minutes or 10 minutes, it will get closer and closer to the state of real-time bidding matching. If the time interval is too long, the overall efficiency of bidding matching will be reduced. This is not conducive to match a large number of positions and resumes as soon as possible. If the time interval is too short, it is difficult for users to complete responding and processing the matching results in time. Therefore, the time interval and the time of a cycle is not as long as possible, nor is it necessarily the shorter the better. In practice, based on the data such as users' behavior, the time interval rule should be determined by analyzing and comparing different time interval which leads to the different rate of final matching success, and the different ratio of matching results responded or processed in time by job-hunters and recruiters.

The present invention application introduces the pre-matching item in the step of S110 named establishing pre-matching relations, which provides convenience for adopting different cycle rules for different regions, industries, and recruitment positions. This facilitates more flexible and more efficient cycle rules.

Specifically, in step S140: bid-matching processing, the procedure of implementing the two-way bidding matching from the two directions of the resume attraction and the position attraction, and generating the bidding matching results is: in each single bid-matching processing, run the bid-matching processing A first, and then run the bid-matching processing B; repeatedly run the single bid-matching processing in a loop until the completion of the two-way bidding matching; the bid-matching processing A and B have the following two categories of type I and type II, and must be one of the two types in a bidding matching cycle.

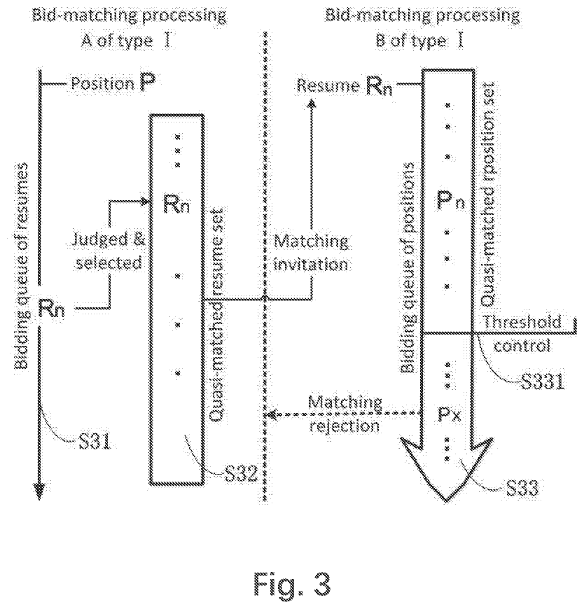

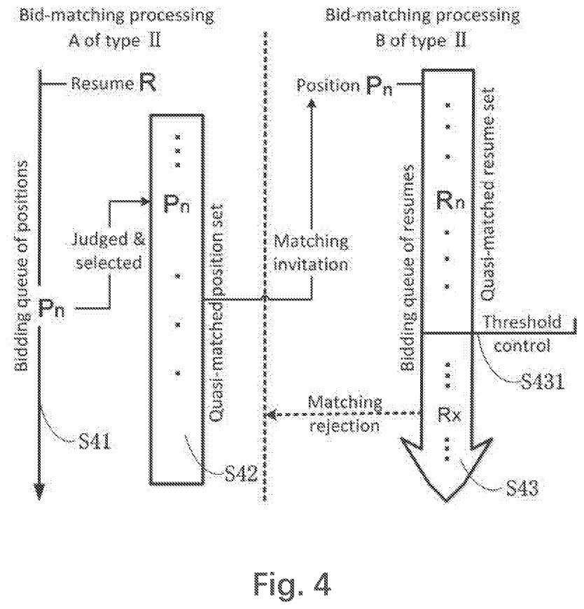

The following is a detailed description for the bid-matching processing of type I and type II with reference to FIG. 3 and FIG. 4.

As shown in FIG. 3, the left side of the middle dashed line is a schematic diagram of the bid-matching processing A of type I, and the right side of the middle dashed line is a schematic diagram of the bid-matching processing B of type I. The bid-matching processing A of type I takes recruitment positions as the bidding matching initiator, and performs the following operations for each current position being processed.

As shown in FIG. 3, the position P is one of the recruitment positions to be matched, and take the position p as an example. The position P is taken as the bidding matching initiator and as the current positon which is being processed currently. The resumes that have established the pre-matching relation with the position P are sorted in descending order according to the attraction value of resume, thereby forming the bidding queue of resumes S31. A batch of resumes that are ranked high in the bidding queue of resumes and meet the filter criteria are preferentially selected into the quasi-matched resume set S32 of the position P. That is to say, every time the bid-matching processing A runs, the following three operations perform:

Firstly, the resumes that have established the pre-matching relation with the current position are sorted in descending order according to the attraction value of resume. Secondly, apply the filter criteria to filter out the resumes that do not meet the filter conditions, that is, filter out those resumes that have successfully established matching relations with the current position before the current round of bid-matching cycle, and filter out the resumes that have issued match rejection to the current position during the current round of bid-matching cycle.

Thirdly, a certain number of resumes that are ranked high and not filter out are selected into the quasi-matched resume set of the current position.

As shown in FIG. 3, the resume Rn, one of the resume in the bidding queue of resumes S31, is selected into the quasi-matched resume set S32.

As the bidding queue of resumes S31 shown in FIG. 3, only the resumes ranked high in the bidding queue can be selected into the quasi-matched resume set. So a threshold is used to limit the upper limit number of resumes in the quasi-matched resume set. In the process of selecting resumes from the bidding queue S31 into the quasi-matched resume set S32, If the number of resumes in the quasi-matched resume set reaches the upper limit controlled by the threshold when the resume Rs has just been selected into the quasi-matched resume set, stop immediately selecting resumes that rank after the resume Rs. Unless in the bid-matching processing B, one or more resumes in the quasi-matched resume set issue matching rejection to the current position P, then the resumes that have issued match rejection will be filtered out of the quasi-matched resume set. And then, in the next repeatedly running of bid-matching processing A, the resumes ranked after the resume Rs will be judged with the filter criteria whether to be selected into the quasi-matched resume set S32.

As the connecting arrow ‘matching invitation’ between S32 and S33 shown in FIG. 3, after the resume Rn is selected into the quasi-matched resume set of the position P, the position P sends a matching invitation to the resume Rn, that is, a matching invitation from the position P is sent to the resume Rn. The matching invitation is a kind of tag used to mark attributes, not some kinds of actual invitations like email.

As shown in the right part of FIG. 3, in the bid-matching processing B of the type I, the recruitment positions that have sent matching invitations to the resume Rn are sorted in descending order according to the value of overall benefits that each position can bring to the resume Rn, thereby forming the bidding queue of positions S33. The resume Rn is one of the resume to be matched, and is taken as an example to explain the process.

Select a batch of top-ranked positions in the bidding queue of positions S33 into the quasi-matched position set of the resume Rn, and use a threshold to control the upper limit number of the positions in the quasi-matched position set. If the number of positions ranked at the top of the bidding queue S33 reaches the threshold number at the position of recruitment position Pe, then those recruitment positions ranked after or bellow Pe will not be selected into the quasi-matched position set. As shown in FIG. 3, the threshold S331 truncates the bidding queue S33 at a certain position. The recruitment positions above the truncated position are the top-ranked positions in the bidding queue of position S33, and these positions are selected into the quasi-matched position set of the resume Rn; the recruitment positions below the truncated position will not be selected into the quasi-matched position set of the resume Rn.

As shown in FIG. 3, for the positions in the bidding queue of positions S33 that cannot be selected into the quai-matched position set, resume Rn sends matching rejection to these positions. In the processing of one round of bid-matching cycle, the resume Rn only needs to send one matching rejection to each position that is not selected into Rn's quai-matched position set. The one round of bid-matching cycle mentioned here refers to the bid-matching processing periodically triggered by the step S130. The matching rejection is also a kind of tag used to mark attributes.

According to the above rules, the bid-matching processing runs from the bid-matching processing A to the bid-matching processing B repeatedly in a loop until the completion of the current round of bid-matching cycle. The completion of the current round of bid-matching cycle means that for all the positions whose pre-matching items match each other, there is not any new resume can be selected into any quasi-matched resume set of these positions in the bid-matching processing A of type L In this case, every quasi-matched resume set and every quasi-matched position set have reached the stable state, that is, there is no new entrant and no longer change. At this time, the resumes in the quasi-matched resume sets are the resumes that successfully establish the matching relation with the position to which the quasi-matched resume set belongs, and the positions in the quasi-matched position set are the positions that successfully establish the matching relation with the resume to which the quasi-matched position set belongs.

As shown in FIG. 3, the arrow “judged to selected” connects S31 and S32. If any resume in the bidding queue of resumes is selected into the quasi-matched resume set of the current recruitment position P, it must first pass the selection criteria. The following two types of resumes are to be blocked or filtered out: (1) In the current round of bid-matching cycle, the resumes that have sent matching rejection to the current position P; (2) before the current round of bid-matching cycle, the resumes that have successfully established matching relation with the current position P.

As explained above, a threshold is used to limit the upper limit number of the quasi-matched resume set. Another threshold is used to limit the upper limit number of the quasi-matched position set. The generating rules of the two thresholds are further introduced as follows.

The method of generating the upper limit threshold for the quasi-matched resume set of the current position includes: based on the number of the resumes that were timely responded and processed by the recruiter to whom the current position belongs to, dynamically generate the threshold; the timely responded and processed resumes are part or all of the resumes that have been successfully matched to the current position in the recent round of bid-matching cycle;

The method of generating the upper limit threshold for the quasi-matched position set of the current resume includes: based on the number of the positions that were timely responded and processed by the job-hunter to whom the current resume belongs to, dynamically generate the threshold; the timely responded and processed positions are part or all of the positions that have been successfully matched to the current resume in the recent round of bid-matching cycle; The responding and processing operations on positions include: applying the position, or marking as unsuitable.

Based on reasonable rules, it is also acceptable to increase or decrease the generated thresholds mentioned above by a certain percentage. The first time when a user activate the bid-matching processing, the user can manually input a number within a certain range as the threshold.

The generating rules for the two thresholds involve the expression of “responded and processed timely”. That is, the job-hunter users and recruiter users should complete browsing the matching results and the related processing operations in time. Or after that the counterparty users have completed processing the matching results, the processed results are responded and processed in time. The responding and processing operations can be marking the matching results as unsuitable, starting a conversation or sending an interview invitation. According to actual needs, the time range needed for timely responding and processing the matching results can be between the two times of bid-matching processing of the latest two rounds of cycle, or not limited to be between the two times of bid-matching processing.

The technical solution of the present invention uses the above two kinds of threshold to define whether a job-hunter or a recruiter is an active user, and to quantify their active levels. Based on the generating rules for the two kinds of threshold described above, it can dynamically adjust the number of matching results according to the actual needs of job-hunters and recruiters. Generally, the larger the number of matching results responded and processed in time, the higher the urgency of job hunting or recruitment. It means that job-hunters or recruiters have the willingness and ability to respond and process many matching results in time, so it is necessary to generate relative more matching results for such users.

Take a recruiter for an example. For the recruiter, the generating rules for the threshold not only satisfy the recruiter's demand for resumes, but also increase the recruiter's chance of being matched with resumes. On the contrary, if the recruiter can not respond and process all matching results in time, the number of matching results generated for the recruiter should be reduced to the actual number of matching results processed by the recruiter in time so as not to waste the opportunity of the matched resumes or job-hunters and cause interference and time waste to job-hunters.

As mentioned above, in the bid-matching processing B of type I, the ranking index for the bidding queue of positions S33 is the value of overall benefits, and the quantified factors for the value of overall benefits include the attractiveness of resumes. To calculate the value of overall benefits, the solution of the present invention application proposes the following solutions.

scheme 1 for the value of overall benefits: without considering factors other than the attractiveness of resumes, the value of overall benefits is simplified to only the attractiveness of resumes, that is

the value of overall benefits=the attraction value of resume.

scheme 2 for the value of overall benefits: introduce the probability of the job-hunter being recruited by the recruiter to which the position belongs, that is

the value of overall benefits=the attraction value of resume*probability of the job-hunter being recruited.

The method for generating the probability of a job-hunter being recruited by a recruiter is to analyze and calculate various factors that can affect the probability, and then generate the probability. The factors that can affect the probability of the job-hunter being recruited include: in the current round of bid-matching processing, the ranking position of the job-hunter's resume in the quasi-matched resume set; the ranking position of the job-hunter's resume in all the resumes that were successfully matched to the recruitment position in the previous rounds of bid-matching cycle; the status of the recruiter's recent recruiting effort. Recent events that can reflect the status of the recruiter's recruiting effort include: the number of resume matching results reviewed by the recruiter, the number of job interviewers invited, and the number of recruitment contracts signed. An example of quantitatively calculating the probability of a job-hunter being recruited is introduced as follows.

Firstly, only consider the status of recruitment position P's quasi-matched resume set in the current round of bid-matching cycle. Suppose that all 62 resumes in the quai-matched resume set are sorted in descending order according to the attraction value of resume, resume R ranks 12th. At the same time, it is also Supposed that the higher the ranking position, the closer the probability of being recruited is to 1, the probability of the last ranking position being recruited is 0.5, and the probability of being recruited decreases linearly as the ranking position decreases. Then the probability Ka of the resume R being recruited is:

Ka=0.5+(1−12/62)*0.5=0.9

Secondly, only consider the “all matched resumes set” which consist of all the resumes that were successfully matched to the recruitment position in the previous rounds of bid-matching cycle before the current round of bid-matching processing. Suppose that the total number of resumes in the “all matched resumes set” is 195, and the resume R is ranked 49th in descending order according to the attraction value of resume. Then the probability Kb of the resume R being recruited is:

Kb=0.5+(1−49/195)*0.5=0.87

Next, suppose that the weights of the three major factors that affect the probability of a job-hunter being recruited are: the weight of the ranking position in the quasi-matched resume set generated by the current round of bid-matching processing is 0.35, the weight of the ranking position in “all matched resumes set” is 0.45, and the weight of the recruiter's recruiting effort is 0.25. And it is assumed that the recruiter's recruiting effort ranks in the top 32% among all bidding recruiters. Then, the probability Ks of the resume R being recruited can be calculated as:

Ks=Ka*0.35+Kb*0.45+(1−32%)*0.25=0.8765

The weights assigned to the above-mentioned different factors that affect the probability can be obtained and continuously optimized through statistical analysis of a large amount of historical data. In the case of less historical data, these weights can be replaced by manual experience assignment.

The above content is an introduction to bid-matching processing of type I, and the following content begins to introduce the bid-matching processing of type II.

As shown in FIG. 4, it is the bid-matching processing of type 11. The left side of the middle dashed line is a schematic diagram of bid-matching processing A of type H, and the right side of the middle dashed line is bid-matching processing B of type U.

As shown in FIG. 4, with the resume R as the bidding matching initiator and as the current resume being processed, the positions that have established the pre-matching relation with the resume R are sorted in descending order according to the overall value of benefits, thereby forming the bidding queue of positions S41. According to the principle of order priority, select a certain number of positions that rank high and meet the filter criteria into the quasi-matched position set S42.

As shown in FIG. 4, the “matching invitation” arrow is connected between the quasi-matched position set S42 on the left and the position Pn on the right, that is, the current resume R sends a matching invitation to the newly selected recruitment position Pn in the quasi-matched position set S42. All the resumes that have sent matching invitations to the position Pn are in the position Pn's bidding queue of resumes 343. In the bidding queue of resumes S43, the resumes are sorted in descending order according to the attraction value of resume. A certain number of resumes that rank high are selected into the quasi-matched resume set of the position Pn, and a matching rejection from the position Pn is issued to those resumes that are not selected. As shown in FIG. 4, the upper limit number of resumes in the quasi-matched resume set is controlled by the threshold S431.

Compared with the bid-matching processing of type I, in which the recruitment positions is taken as the bidding initiator, the core difference of the type II bid-matching processing is that it takes resumes as the bid-matching initiator. As a result, the main difference in the subsequent entire bid-matching processing is that the positional relationship between recruitment positions and resumes is exchanged. But the processes and processing methods involved in the bid-matching processing are the same. Therefore, the content of this part does not repeat the description of these processes and processing methods.

Specifically, in step S150: feedback for the bidding matching results. After the bid-matching processing in the step S140, the bidding matching results are fed back to job-hunters and recruiters, and accepted users operations on the matching results.

In the step S150 for the feedback of bid-matching results, the bid-matching transaction prices are also fed back for each pair of successfully matched resumes and positions, and the conditions satisfied by the bid-matching transaction price include: the bid-matching transaction price is not less than the lower limit of the salary and benefits demanded by a job-hunter, and not higher than the upper limit of the salary and benefits offered by the recruiter for a position; the higher the upper limit of the salary and benefits offered by a recruiter, the higher the bid-matching transaction price.

Based on this principle, many methods used to generate the transaction price can be designed. Here are just two example.

Example one: sum the upper limit of the salary and benefits offered by a recruiter and the lower limit of the salary and benefits demanded by a job-hunter, and then divide it by 2 to take the average as the transaction price.

Example two: after the successful matching relation between a resume and a recruitment position is successfully established, the average value of the lower limit of the salary and benefits demanded by the resume and the upper limit of the salary and benefits offered by the recruitment position is taken as the bidding reference price. The bidding reference prices of the current resume with all successfully matched positions are sorted from large to small to form a bidding reference prices queue. Assuming that there are three consecutive bidding reference prices Pn+1, Pn and Pn−1 on the reference prices queue, which correspond to the recruitment position J, D and K respectively, then the bid-matching transaction price P between current resume and the position J depends on the bidding reference price Pn that ranks one place after the bidding reference price with position J on the reference price queue. That is P=(1+k)*Pn, where k is a custom constant, k is not less than 0 and not more than 0.2.

In each round of bid-matching cycle, the selection and filtering out operations are all based on the bidding matching constraints as described above. As the bidding matching processing runs from bid-matching processing A to bid-matching processing B repeatedly in a loop, the matched resumes for each position are becoming more and more two-way optimal, and the matched positions for each resume are also becoming more and more two-way optimal. This is a kind of two-way approaching effect, which will eventually approach to the two-way optimal matching results for both sides of recruiters and job-hunters. This kind of two-way approaching effect is similar to the Gale-Shapley algorithm (also called the GS algorithm or the delayed acceptance algorithm). The correctness of the Gale-Shapley algorithm has been widely proven both theoretically and practically. But the solution supplied by the present invention application has the following three core differences from the GS algorithm.

Firstly, the process mode is different. The GS algorithm only runs one round of matching processing, while the solution of the present invention application has such a unique design that the running of bid-matching processing is periodically triggered through the mechanism of bid-matching cycles. As a result, the matching processing of the present application periodically run countless rounds of bid-matching processing. After each round of bid-matching processing, the newly inputted resumes and recruitment positions in the bid-matching system, as well as the modification on resumes and positions, are all accepted by the bid-matching system, and these new data will be putted in the bid-matching processing in the next round of bid-matching cycle.

Secondly, the use mode of the matching results is different. After the GS algorithm runs a round of matching processing, the final matching results for the matching participants are generated. But the matching results generated by the scheme of the present invention application are only matching recommendations, not the final matching results. At the same time, the number of matching recommendations is obviously larger than the actual need of bidding matching participants, so participants can select one or several recommendations that best suit their need as the final matching results.

Thirdly, the application scenario is different. The GS algorithm is used in the scenario where the matching tendency of matching participants is clear, and the quantity and scale of participants to be matched are determined. However, the application scenario of the present invention application not only has unclear subjective matching tendency of matching participants, but also has a large number of matching participants, and the quantity and scale of matching participants are changing dynamically. That is to say, recruiters are usually faced with a huge number of resumes, and job-hunters are usually faced with a huge number of positions, and both parties do not know which are the appropriate choices for them. In addition, new recruitment positions and resumes are constantly being entered into the bidding matching system, and are processed by the bid-matching processing. The modifications on the resumes and positions are also accepted. These differences in the scenario are beyond the reach of the GS algorithm.

To solve these problems, the present invention application presents a series of technical solutions. Because of the matching tendency of job-hunters and recruiters is unclear, the bidding matching indicators adopted by the present application are the attraction value of resume, the attraction value of position, and the overall value of benefits, which completely abandon the subjective wishes of job-hunters or recruiters. It is precisely because that the quantity of job-hunting resumes and recruitment positions are huge and in dynamic change, so the solution of the present application is designed to periodically run the bidding matching processing, and the bidding matching results are periodically generated batches after batches. The bidding matching results are generated batches after batches, so the bidding matching participants will find their suitable job-hunters or recruiters in the gradually expanding scope of matching results.

The second aspect of the present invention application is described as follows: a cyclic two-way bidding matching system based on the needs of both job-hunters and recruiters, the system is used to implement the cyclic two-way bidding matching method provided by the first aspect of the present invention application. In the main steps and the specific implementation of the core process, the system of the second aspect of the present invention application is completely consistent with the method of the first aspect described above, so the following descriptions are simplified.

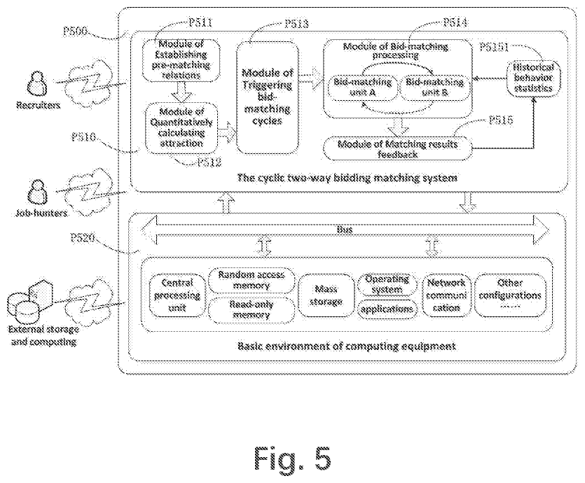

As shown in FIG. 5, it is the overall system graphic for illustrating the solutions of present invention application, a cyclic two-way bidding matching system based on the needs of both sides of job-hunters and recruiters.

As shown in FIG. 5, P500 is a computer device running the system of the second aspect of the present invention application, and P500 is composed of two parts, P520 and P510. P520 is the basic environment of computing equipment, including processor, random access memory, read-only memory, mass storage, operating system, application programs, network communication and other equipment and configurations. The cyclic two-way bidding matching system P510 of the present invention application runs on the basic equipment environment provided by P520. The memory of the P520 stores at least one instruction, at least one piece of program, code set or instruction set of the system P510. The at least one instruction, the at least one piece of program, and the code set or the instruction set are loaded and executed by the processor of the P520 to run the system P510 of the present invention. The memory and mass storage of the P520 also store the intermediate data and the result data of the system P510.

As shown in FIG. 5, the computing device P500 in which the system of the present invention runs connects both sides of job-hunters and recruiters through the network, and provides services for both sides. According to actual needs, the computing device P500 can also be connected to external memory and computing devices through network fibers and other means.

As shown in FIG. 5, the cyclic two-way bidding matching system P510 based on the needs of both job-hunters and recruiters includes the following five modules running periodically:

module P511 for establishing pre-matching relations, process the newly inputted and existing recruitment positions and job-hunting resumes in the bid-matching system, compare the pre-matching items of the positions and the resumes, and establish a pre-matching relation between the positions and resumes whose pre-matching items match each other; the pre-matching item include: industry field, job title, work area;

module P512 for quantitatively calculating attraction, for the resumes and positions that have establish the pre-matching relation, quantitatively calculate the attraction value of each resume to each recruitment position, that is, the attraction value of resume; quantitatively calculate the attraction value of each position to each resume, that is, the attraction value of position; the quantified factors for the attraction value of resume include: the matching degree of a resume to a position; the quantified factors for the attraction value of position include: salary offered by a position;

module P513 for triggering bid-matching cycles, set the bidding matching system to run periodically, the bid-matching processing of the module P514 is triggered to run at the beginning of every round of bid-matching cycle; the other four modules also run in every round of bid-matching cycle;

module P514 for bid-matching processing, the procedure of implementing the two-way bidding matching from the two directions of the resume attraction and the position attraction, and generating the bidding matching results is: in each single bid-matching processing, run the bid-matching unit A firstly, and then run the bid-matching unit B; repeatedly run the single bid-matching processing in a loop until the completion of the two-way bidding matching; the bidding matching unit A and unit B have the following two categories of type I and type II, and must be one of the two types in a bid-matching cycle;

the bid-matching unit A of type I takes the recruitment positions as the bidding initiator, and performs the following operations for each current position being processed: first sort the resumes that have established the pre-matching relation with the current position in descending order according to the attraction value of resume, thereby forming a bidding queue of resumes; and then based on sorting priority, select a certain number of resumes that are ranked high and meet the filter criteria into the quasi-matched resume set of the current position; send matching invitations from the current position to those resumes that are newly selected into the quasi-matched resume set in the current processing of bid-matching unit A;

the bid-matching unit B of type I performs the following operations for each current resume being processed: for those positions that have sent matching invitations to the current resume, quantitatively calculate the value of overall benefits that each position can bring to the current resume; sort these positions in descending order according to the value of overall benefits, thereby forming a bidding queue of positions, and then based on sorting priority, select a certain number of positions that are ranked high into the quasi-matched position set of the current resume; send matching rejection from the current resume to the positions that have not been selected into the quasi-matched position set in the current processing of bid-matching unit B; the quantitative calculation factors for the overall benefits include: the attraction value of position;

the bid matching unit A of type II takes resumes as the bidding initiator, and performs the following operations for each current resume being processed: first sort the positions that have established the pre-matching relation with the current resume in descending order according to the value of overall benefits that each position can bring to the current resume, thereby forming a bidding queue of positions; and then based on sorting priority, select a certain number of positions that are ranked high and meet the filter criteria into the quasi-matched position set of the current resume; send matching invitations from the current resume to those positions that are newly selected into the quasi-matched positon set in the current processing of bid-matching unit A; the quantitative calculation factors for the overall benefits include: the attraction value of position;

the bid-matching unit B of type II performs the following operations on each current position being processed: sort those resumes that have sent matching invitations to the current position in descending order according to the attraction value of resume, thereby forming a bidding queue of resumes, and then based on sorting priority, select a certain number of resumes that are ranked high into the quasi-matched resume set of the current positon; send matching rejection from the current positon to the resumes that have not been selected into the quasi-matched resume set in the current processing of bid-matching unit B;

the completion of the bidding matching is that the quasi-matched resume set of each position participating in the bidding matching have no newly selected resume, or the quasi-matched position set of each resume participating in the bidding matching have no newly selected position; at this time, the resumes in the quasi-matched resume set are successfully matched to the current position, and the positions in the quasi-matched position set are successfully matched to the current resume;

module P515 for feedback of bidding matching results, after the completion of the bidding matching, the bidding matching results can be fed back to users by actively pushing or responding to users' query; then users can process the matching results.

As shown in FIG. 5, in the running of bid-matching unit A, the bid-matching processing module P514 takes the following filter criteria on the selection for the quasi-matched resume set and the quasi-matched position set:

in the bid-matching unit A of type I, when selecting resumes into the quasi-matched resume set, those resumes that have been rejected for matching to the current position in the current round of bid-matching cycle are excluded, and resumes that have successfully matched to the current position before the current round of bid-matching cycle are excluded; in the bid-matching unit A of type II, when selecting positions into the quasi-matched position set, those positions that have been rejected for matching to the current resume in the current round of bid-matching cycle are excluded, and positions that have successfully matched to the current resume before the current round of bid-matching cycle are excluded.

As shown in FIG. 5, in the process of bid-matching processing, the bid-matching processing module P514 controls the upper limit of the number of resumes in the quasi-matched resume set with a threshold, and controls the upper limit of the number of positions in the quasi-matched position set with another threshold. The method for generating the two thresholds comprising: the method of generating the upper limit threshold for the quasi-matched resume set of the current position includes: based on the number of the resumes that were timely responded and processed by the recruiter to whom the current position belongs to, dynamically generate the threshold; the timely responded and processed resumes are part or all of the resumes that have been successfully matched to the current position in the recent round of bid-matching cycle;

the method of generating the upper limit threshold for the quasi-matched position set of the current resume includes: based on the number of the positions that were timely responded and processed by the job-hunter to whom the current resume belongs to, dynamically generate the threshold; the timely responded and processed positions are part or all of the positions that have been successfully matched to the current resume in the recent round of bid-matching cycle.

As shown in in FIG. 5, the module P514 for bid-matching processing. In the bid-matching processing unit B of type I and the bid-matching processing unit A of type II, quantitatively calculate the value of overall benefits that each position can bring to the current resume. The present invention application provides the following embodiment for the value of overall benefits:

The value of overall benefits=the attraction value of position*probability of the job-hunter being recruited.

If the probability of the job-hunter being recruited is simplified and the probability is taken as 1, then the value of overall benefits=the attraction value of position.

The method for quantitatively calculate the probability of a job-hunter being recruited is to analyze and calculate various factors that can affect the probability. The factors that can affect the probability of a job-hunter being recruited include: the ranking position of the job-hunter's resume in the quasi-matched resume set, in the current round of bid-matching processing; the ranking position of the job-hunter's resume in all the resumes that were successfully matched to the job position in previous rounds of bid-matching processing; the state of the recruiter's recent recruitment efforts. Recent events that can reflect the state of the recruiter's recent recruitment efforts include: the number of resume matching results reviewed by the recruiter, the number of job interviewers invited, and the number of job-hunters being recruited.

As shown in FIG. 5, the module P515 for feedback of bidding matching results. The bidding matching results are fed back to job-hunters and recruiters in the way of actively pushing or responding to the users' query. Then job-hunters and recruiters can respond and process the matching results.

As shown in in FIG. 5, the historical behavior statistics unit P5151 records the historical behavior of users' response and processing to the matching results, and analyzes these historical behavior data to generate the parameters required by the bid-matching processing module P514, such as the threshold used for controlling the upper limit number of resumes in the quasi-matched resume set, and the threshold used for controlling the upper limit number of positions in the quasi-matched position set.

In the module P515 for feedback of bidding matching results, the bidding matching transaction price is also fed back for each pair of the successfully matched resume and position, and the conditions satisfied by this bidding matching transaction price include: the bidding matching transaction price is not less than the lower limit of the salary and benefits demanded by a job-hunter, and is not higher than the upper limit of the salary and benefits offered by the recruiter for a position; the higher the upper limit of the salary and benefits offered by the recruiter, the higher the bidding matching transaction price.

Based on this principle, many methods for generating the transaction price can be designed. Here is just one example: sum the upper limit of the salary and benefits offered by the position and the lower limit of the salary and benefits asked by the resume, and then divide it by 2 to take the average as the transaction price.

The method and system presented by this invention application described above generates the needed number of bidding matching results for each bidding matching participant (ie job-hunters, recruiters), and the needed number is generated on the base of the number of the timely responded and processed matching results by each participant. This is extremely important, because it not only greatly narrows the scope of data each job-hunter or each recruiter needs to deal with, but also ensures that the narrowed scope of data is full of active job-hunters and recruiters. The reason is that the active level of job-hunters and recruiters is guaranteed by everyone's number of the timely responded and processed matching results. The bid-matching processing in each round of bid-matching cycle generates the two-way optimal matching results that meet the bidding matching constraints, and this kind of matching results are the truly optimal matching results for both sides of job-hunters and recruiters. Such optimal matching results not only satisfy the need of each bid-matching participant to the greatest extent, but also maximize the matching value for both sides of job-hunters and recruiters. With such rounds after rounds of cyclic bidding matching, the optimal matching results generated for every bidding matching participant gradually expand in scope until they find their suitable job-hunter or recruiter.

Obviously, the embodiments, examples and descriptions described above are only some preferred embodiments, examples and descriptions of the present invention application, not all of them. Based on the technical scheme of the invention and its principle and spiritual essence, all other embodiments and examples obtained by ordinary technicians in the related field without creative work fall within the scope protected by the present invention. With regard to the technical proposal disclosed by the invention, ordinary technical personnel in the field, without any creative work, getting the methods, processes, rules, systems or modules of the invention by including but not limited to adjusting, replacing, changing the order, recombining, are all violations of the protection scope of the present invention.

1. A cyclic two-way bidding matching method based on the needs of both sides of job-hunters and recruiters, comprising the following five periodic cycle steps:
establishing pre-matching relations, for the the existing and newly inputted recruitment positions and job-hunting resumes in the bid-matching system, compare the pre-matching items of the positions and the resumes, and establish a pre-matching relation between the positions and resumes whose pre-matching items match each other; the pre-matching item include: industry field, job title, work area;
quantitatively calculating attraction, for the resumes and positions that have established the pre-matching relation, quantitatively calculate each resume's attraction to each position to get the attraction value of resume; quantitatively calculate each position's attraction to each resume to get the attraction value of position; the quantified factors for resumes' attraction include: the matching degree of a resume to a position; the quantified factors for positions' attraction include: salary offered by a position;
triggering bid-matching cycles, set the bid-matching system to run periodically, the next step of bid-matching processing is triggered to perform at the beginning of every round of bid-matching cycle; the other four steps also perform in every round of bid-matching cycle;
bid-matching processing, the procedure of implementing the two-way bidding matching from the two directions of resume attraction and position attraction, and generating the bidding matching results includes: in each single bid-matching processing, run bid-matching processing A first, and then run bid-matching processing B; repeatedly run the single bid-matching processing in a loop until the completion of the bid-matching processing; the bid-matching processing A and B are one of the following two categories of type I and type II;
the bid-matching processing A of type I takes recruitment positions as the bidding matching initiator, and performs the following operations for each current position being processed: first sort the resumes that have established the pre-matching relation with the current position in descending order according to the attraction value of resume, thereby forming a bidding queue of resumes; and then based on sorting priority, select a certain number of resumes that are ranked high and meet the filter criteria into the quasi-matched resume set of the current position; send matching invitations from the current position to the resumes that have been newly selected into the quasi-matched resume set in the current bid-matching processing A;
the bid-matching processing B of type I performs the following operations for each current resume being processed: for the positions that have sent matching invitations to the current resume, quantify the value of overall benefits that each position can bring to the current resume; sort these positions in descending order according to the value of overall benefits, thereby forming a bidding queue of positions, and then based on sorting priority, select a certain number of positions that are ranked high into the quasi-matched position set of the current resume; send matching rejection from the current resume to the positions that have not been selected into the quasi-matched position set in the current bid-matching processing B; the quantified factors for the value of overall benefits include: the attraction value of position;
the bid-matching processing A of type II takes job-hunting resumes as the bidding matching initiator, and performs the following operations for each current resume being processed: first sort the positions that have established the pre-matching relation with the current resume in descending order according to the value of overall benefits that each position can bring to the current resume, thereby forming a bidding queue of positions; and then based on sorting priority, select a certain number of positions that are ranked high and meet the filter criteria into the quasi-matched position set of the current resume; send matching invitations from the current resume to those positions that have been newly selected into the quasi-matched positon set in the current bid-matching processing A; the quantified factors for the value of overall benefits include: the attraction value of position;
the bid-matching processing B of type II performs the following operations for each current position being processed: sort the resumes that have sent matching invitations to the current position in descending order according to the attraction value of resume, thereby forming a bidding queue of resumes, and then based on sorting priority, select a certain number of resumes that are ranked high into the quasi-matched resume set of the current positon; send matching rejection from the current positon to the resumes that have not been selected into the quasi-matched resume set in the current bid-matching processing B;
the completion of the two-way bidding matching is that the quasi-matched resume set of each position participating in the bidding matching has no newly selected resume, or the quasi-matched position set of each resume participating in the bidding matching has no newly selected position;
at this time, the resumes in the quasi-matched resume set are successfully matched to the current position, and the positions in the quasi-matched position set are successfully matched to the current resume;
feedback for the bidding matching results, after the completion of the bid-matching processing, the bidding matching results can be fed back to users by actively pushing or responding to users' query; then users can process the bidding matching results.

2. The method of claim 1, wherein in the bid-matching processing A, the following filter criteria is imposed on the selection for the quasi-matched resume set and the quasi-matched position set:
in the bid-matching processing A of type I, when select resumes into the quasi-matched resume set, the resumes that have send matching rejection to the current position in the current round of bid-matching cycle are excluded, and the resumes that have successfully matched to the current position before the current round of bid-matching cycle are also excluded;
in the bid-matching processing A of type U, when select positions into the quasi-matched position set, the positions that have send matching rejection to the current resume in the current round of bid-matching cycle are excluded, and the positions that have successfully matched to the current resume before the current round of bid-matching cycle are also excluded.

3. The method of claim 1, wherein the upper limit of the number of resumes in the quasi-matched resume set is limited by a threshold, and the upper limit of the number of positions in the quasi-matched position set is also limited by a threshold.

4. The method of claim 3, wherein the method of generating the thresholds comprising:
the method of generating the upper limit threshold for the quasi-matched resume set of the current position includes: based on the number of the resumes that were timely responded and processed by the recruiter to whom the current position belongs to, dynamically generate the threshold; the timely responded and processed resumes are part or all of the resumes that have been successfully matched to the current position in the recent round of bid-matching cycle;
the method of generating the upper limit threshold for the quasi-matched position set of the current resume includes: based on the number of the positions that were timely responded and processed by the job-hunter to whom the current resume belongs to, dynamically generate the threshold; the timely responded and processed positions are part or all of the positions that have been successfully matched to the current resume in the recent round of bid-matching cycle.

5. The method of claim 1, wherein in the bid-matching processing A of type II and bid-matching processing B of type I, the method of quantifying the value of overall benefits includes:
the value of overall benefits=(the attraction value of position)*(probability of the job-hunter being recruited); the probability is generated by statistically calculating various factors that can affect the job-hunter being recruited.

6. The method of claim 1, wherein in the step of feedback for the bidding matching results, the bid-matching transaction prices are also fed back, and the conditions satisfied by the bid-matching transaction price include:
the bid-matching transaction price is not less than the lower limit of the salary and benefits demanded by a job-hunter, and is not higher than the upper limit of the salary and benefits offered by the recruiter for a position; the higher the upper limit of the salary and benefits offered by the recruiter, the higher the bid-matching transaction price.

7. A cyclic two-way bidding matching system running on computer equipment that constitutes a basic environment by processors, memories, storage devices, programs, instructions, data, communication interfaces, and the like, comprising the following five modules running in periodic cycle:
module for establishing pre-matching relations, for the existing and the newly inputted recruitment positions and job-hunting resumes in the bid-matching system, compare the pre-matching items of the positions and the resumes, establish a pre-matching relation between the positions and resumes whose pre-matching items match each other; the pre-matching item include: industry field, job title, work area;
module for quantitatively calculating attraction, for the resumes and positions that have establish the pre-matching relation with each other, quantitatively calculate each resume's attraction to each position to get the attraction value of resume; quantitatively calculate each position's attraction to each resume to get the attraction value of position; the quantified factors for resumes' attraction include: the matching degree of a resume to a position; the quantified factors for positions' attraction include: salary offered by a position;
module for triggering bid-matching cycles, set the bid-matching system to run periodically, the bid-matching processing is triggered to run at the beginning of every round of bid-matching cycle;
the other four modules also run in every round of bid-matching cycle;
module for bid-matching processing, the procedure of implementing the two-way bidding matching from the two directions of resume attraction and position attraction, and generating the bidding matching results includes: in each single bid-matching processing, run the bid-matching unit A first, and then run the bid-matching unit B; repeatedly run the single bid-matching processing in a loop until the completion of the bid-matching processing; the bid-matching unit A and unit B are one of the following two categories of type I and type II;
the bid-matching unit A of type I takes the recruitment positions as the bidding matching initiator, and performs the following operations for each current position being processed: first sort the resumes that have established the pre-matching relation with the current position in descending order according to the attraction value of resume, thereby forming a bidding queue of resumes;
and then based on sorting priority, select a certain number of resumes that are ranked high and meet the filter criteria into the quasi-matched resume set of the current position; send matching invitations from the current position to the resumes that have been newly selected into the quasi-matched resume set in the current processing of bid-matching unit A;
the bid-matching unit B of type I performs the following operations on each current resume being processed: for the positions that have sent matching invitations to the current resume, quantify the value of overall benefits that each position can bring to the current resume; sort these positions in descending order according to the value of overall benefits, thereby forming a bidding queue of positions; then based on sorting priority, select a certain number of positions that are ranked high into the quasi-matched position set of the current resume; send matching rejection from the current resume to the positions that have not been selected into the quasi-matched position set in the current processing of bid-matching unit B; the quantified factors for the value of overall benefits include: the attraction value of position;
the bid-matching unit A of type II takes the job-hunting resumes as the bidding matching initiator, and performs the following operations for each current resume being processed: first sort the positions that have established the pre-matching relation with the current resume in descending order according to the value of overall benefits that each position can bring to the current resume, thereby forming a bidding queue of positions; and then based on sorting priority, select a certain number of positions that are ranked high and meet the filter criteria into the quasi-matched position set of the current resume; send matching invitations from the current resume to the positions that have been newly selected into the quasi-matched positon set in the current processing of bid-matching unit A; the quantified factors of the overall benefits include: the attraction value of position;
the bid-matching unit B of type II performs the following operations on each current position being processed: sort the resumes that have sent matching invitations to the current position in descending order according to the attraction value of resume, thereby forming a bidding queue of resumes; then based on sorting priority, select a certain number of resumes that are ranked high into the quasi-matched resume set of the current positon; send matching rejection from the current positon to the resumes that have not been selected into the quasi-matched resume set in the current processing of bid-matching unit B;
the completion of the two-way bidding matching is that the quasi-matched resume set of each position participating in the bidding matching have no newly selected resume, or the quasi-matched position set of each resume participating in the bidding matching have no newly selected position; at this time, the resumes in the quasi-matched resume set are successfully matched to the current position, and the positions in the quasi-matched position set are successfully matched to the current resume;
module for feedback of bidding matching results, after the completion of the bid-matching processing, the bidding matching results can be fed back to users by actively pushing or responding to users' query; then users can process the bidding matching results.

8. The system of claim 7, wherein in the running of bid-matching unit A, the following filter criteria is imposed on the selection for the quasi-matched resume set and the quasi-matched position set:
in the running of bid-matching unit A of type I, when select resumes into the quasi-matched resume set, the resumes that have send matching rejection to the current position in the current round of bid-matching cycle are excluded, and the resumes that have successfully matched to the current position before the current round of bid-matching cycle are also excluded;
in the running of bid-matching unit A of type II, when select positions into the quasi-matched position set, the positions that have send matching rejection to the current resume in the current round of bid-matching cycle are excluded, and the positions that have successfully matched to the current resume before the current round of bid-matching cycle are also excluded.

9. The system of claim 7, wherein the upper limit of the number of resumes in the quasi-matched resume set is limited by a threshold, and the upper limit of the number of positions in the quasi-matched position set is also limited by a threshold.

10. The system of claim 9, wherein the method of generating the thresholds comprising:
the method of generating the threshold for the quasi-matched resume set of the current position includes: based on the number of the resumes that were timely responded and processed by the the recruiter to whom the current position belongs to, dynamically generate the threshold; the timely responded and processed resumes are part or all of the resumes that have been successfully matched to the current position in the recent round of bid-matching cycle;
the method of generating the threshold for the quasi-matched position set of the current resume includes: based on the number of the positions that were timely responded and processed by the job-hunter to whom the current resume belongs to, dynamically generate the threshold; the timely responded and processed positions are part or all of the positions that have been successfully matched to the current resume in the recent round of bid-matching cycle.

11. The system of claim 7, wherein in the running of bid-matching unit B of type I, and in the running of bid-matching unit A of type II, the method of quantifying the value of overall benefits includes:
the value of overall benefits=(the attraction value of position)*(probability of the job-hunter being recruited); the probability is generated by statistically calculating various factors that can affect the job-hunter being recruited.

12. The system of claim 7, wherein in the running of module for feedback of bidding matching results, the bid-matching transaction prices are also fed back, and conditions satisfied by the bid-matching transaction price include:
the bid-matching transaction price is not less than the lower limit of the salary and benefits demanded by a job-hunter, and is not higher than the upper limit of the salary and benefits offered by the recruiter for a position; the higher the upper limit of the salary and benefits offered by the recruiter, the higher the bid-matching transaction price.
